(19) United States
(12) Patent Application Publication
(10) Pub. No.: US 2008/0256916 A1
(43) Pub. Date: Oct. 23, 2008

(54) Raking Device Disposed Between Outer Raking Devices

(76) Inventors: Michael Vaske, Knoxville, IA (US); Michael Kindley, Oskaloosa, IA (US); Philip Egging, Reasnor, IA (US)

Correspondence Address: STURM & FIX LLP, 206 SIXTH AVENUE, SUITE 1213, DES MOINES, IA, 50309-4076, US

(21) Appl. No.: 11/736,371

(22) Filed: Apr. 17, 2007

(51) Int. Cl. A01D 78/14

(52) U.S. Cl. 56/13.5

(57) ABSTRACT

An implement for raking a crop disposed on ground in a field has a frame adapted to be operatively attached to a prime mover, the frame having a front end and a rear end and being adapted to be moved in a forward direction by the prime mover. A first raking device has an inner end and an outer end, the first raking device being operatively attached to the frame for moving a crop inwardly towards the inner end thereof to form part of a first windrow. A second raking device has an inner end and an outer end, the second raking device being operatively attached to the frame for moving a crop inwardly towards the inner end thereof to form another part of the first windrow. The inner end of the first raking device is spaced from the inner end of the second raking device, thereby forming a space between the inner ends of the first and second raking devices, a front end of said first windrow being disposed at least partially in said space. A third raking device is disposed forwardly of the space between the first and second raking devices for moving a crop outwardly and to at least one side of the space to form a second windrow in front of and between the inner and outer ends of at least one of the first and second raking devices. The third raking device also forms a third windrow in front of and between the inner and outer ends of the other one of the first and second raking devices so that the third windrow will also form part of the first windrow as the implement moves forwardly through the field.

### FIELD OF THE INVENTION

The present invention relates generally to agricultural equipment, and more specifically to a folding frame for an agriculture implement such as a Crop Raking Method and Apparatus, for example as an improvement to a twin basket rake or to a twin wheel rake.

### BACKGROUND

The process of baling agricultural crops starts when the crop is cut or mowed and laid onto the ground in an arrangement to aid drying. After reaching an initial dried condition, the process typically includes a raking step where the crop is formed into a windrow to enhance the final drying process. Since the capacity of balers is affected by the form and size of the final windrow, the raking process is also used to arrange the crop into a windrow that is optimized for baling.

The raking process often involves collecting the crop material over a wide swath to increase the density of the crop in the final windrow of an adjustable width. It is common to use twin rakes, including left and right side rakes that move material toward the center, thereby efficiently forming the desirable final windrow.

The frame that carries the side rakes of a wide twin rake must provide adequate flotation to allow the raking elements to follow variations in the terrain. They also need to position the raking baskets to provide varying windrow widths and to move between a folded transport configuration and an extended operating configuration; the frames thus typically include a folding linkage, a windrow width linkage, and a lift linkage. One such folding twin rake is shown in U.S. patent application Ser. No. 11/161,594 filed Aug. 9, 2005, now published application #20070033915, now U.S. Pat. No. ______, which patent application is incorporated herein by reference in its entirety.

One problem with twin rakes is that the crop immediately under where the windrow is formed has never been lifted from the ground before it is later picked up by a baler for baling. Accordingly this portion of the crop will not dry as quickly as the crop that has been picked up from the ground and moved into the windrow. Also, because this crop immediately under the windrow has never been lifted from the ground since cutting, it will be lower to the ground and therefore be harder for the baler pickup to move it into the baler. Accordingly, it is more likely that the baler pickup will leave some of this previously un-raked crop on the ground instead of moving it into the baler as desired.

Therefore, there is a need for an improvement to a twin rake to overcome the aforementioned deficiencies.

### SUMMARY

The present invention relates to an implement for raking a crop disposed on ground in a field has a frame adapted to be operatively attached to a prime mover, the frame having a front end and a rear end and being adapted to be moved in a forward direction by the prime mover. A first raking device has an inner end and an outer end, the first raking device being operatively attached to the frame for moving a crop inwardly towards the inner end thereof to form part of a first windrow. A second raking device has an inner end and an outer end, the second raking device being operatively attached to the frame for moving a crop inwardly towards the inner end thereof to form another part of the first windrow. The inner end of the first raking device is spaced from the inner end of the second raking device, thereby forming a space between the inner ends of the first and second raking devices, a front end of said first windrow being disposed at least partially in said space.

A third raking device is disposed forwardly of the space between the first and second raking devices for moving a crop outwardly and to at least one side of the space to form a second windrow in front of and between the inner and outer ends of at least one of the first and second raking devices. The third raking device also, in a preferred embodiment thereof, forms a third windrow in front of and between the inner and outer ends of the other one of the first and second raking devices so that the third windrow will also form part of the first windrow as the implement moves forwardly through the field.

### BRIEF DESCRIPTION OF THE DRAWINGS

FIG. 1 is a perspective view of a folding twin basket rake with the present invention attached to it.

FIG. 2 is a perspective view of the present invention on a folding twin basket rake in a field during a raking operation when the present invention is raised and not in use;

FIG. 3 is a perspective view of the present invention on a folding twin basket rake in a field during a raking operation with the present invention center windrow splitter in use;

FIG. 4 is a top plan view of the present invention as an attachment for a twin rake and showing the rotational movement of two powered splitter rotors. FIG. 5 is a side elevational view of the attachment of the present invention in a position like that shown in the lowered operational position shown in FIG. 3, FIG. 5 being a view from the right side thereof with the forward direction of movement of the twin rake frame being to the left as viewed in FIG. 5;

FIG. 6 is a side elevational view of the attachment of the present invention in a position like that shown in the partially raised non-operational position shown in FIG. 2, FIG. 6 being a view from the right side thereof with the forward direction of movement of the twin rake frame being to the left as viewed in FIG. 6;

FIG. 7 is a side elevational view of the attachment of the present invention in a position like that shown in a fully raised non-operational position shown in FIG. 2, FIG. 7 being a view from the right side thereof with the forward direction of movement of the twin rake frame being to the left as viewed in FIG. 7;

FIG. 8 is a schematic view of a preferred embodiment of the hydraulic system of the present invention for controlling the left and right side basket motors and the left and right side splitter motors;

FIG. 9 is a schematic view of a preferred embodiment of the hydraulic control system for lifting, folding and controlling the windrow width of a preferred embodiment of the present invention; and

FIG. 10 is a perspective view of a folding twin tool bar wheel rake having the present invention attached thereto.

### DETAILED DESCRIPTION OF THE PREFERRED EMBODIMENTS

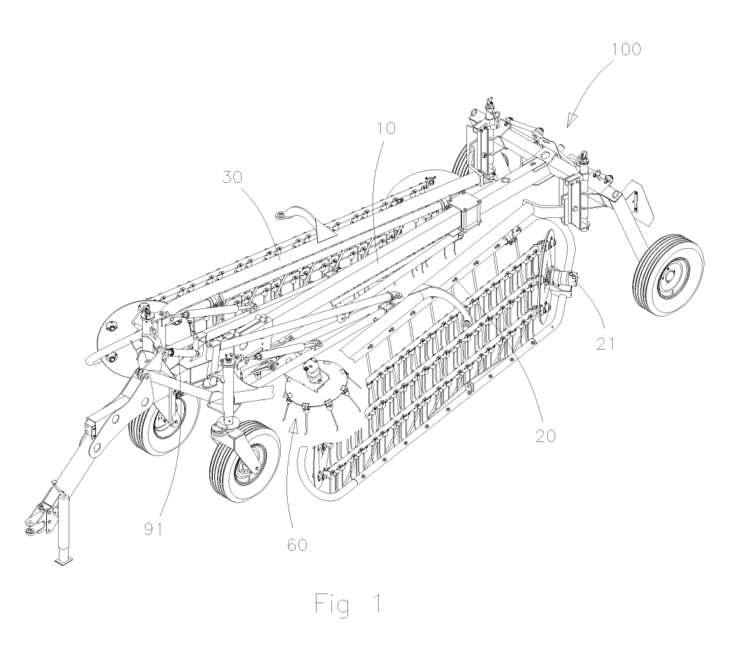

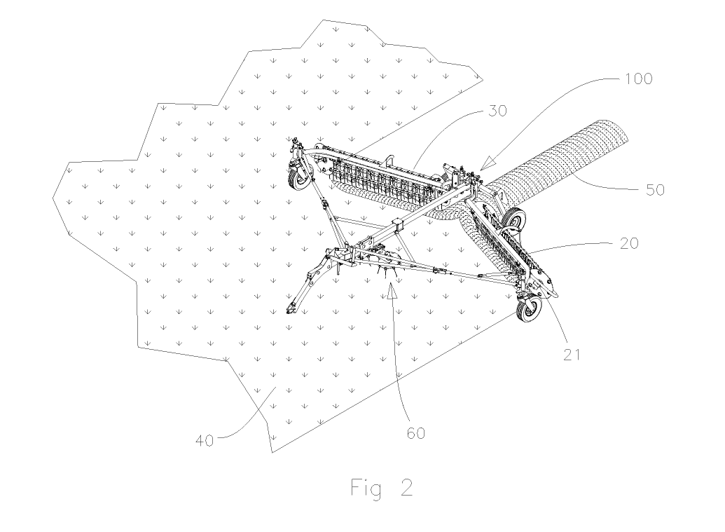

Referring now to the drawings wherein like reference numerals designate identical or corresponding parts throughout the several views, FIG. 1 shows a twin folding basket rake 100 in a transport position constructed in accordance with the present invention. This twin basket rake is shown in more detail in U.S. patent application Ser. No. 11/161,594 filed Aug. 9, 2005, now published as US Patent Application number 20070033915, which patent application is incorporated herein in its entirety. Accordingly, the details of this twin folding basket rake will not be disclosed in detail herein.

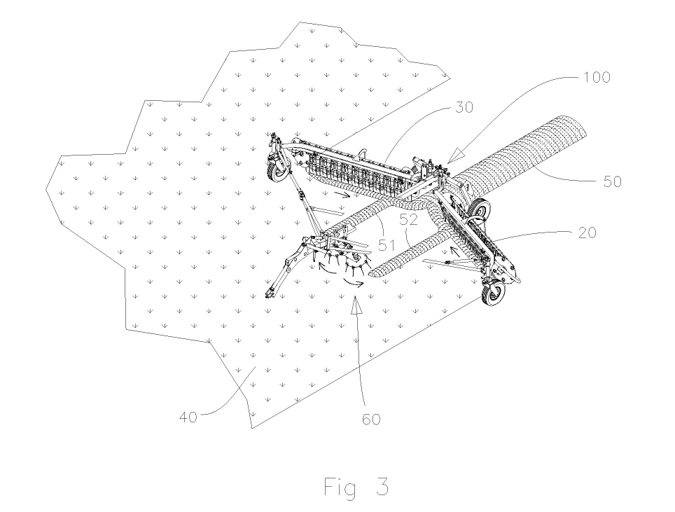

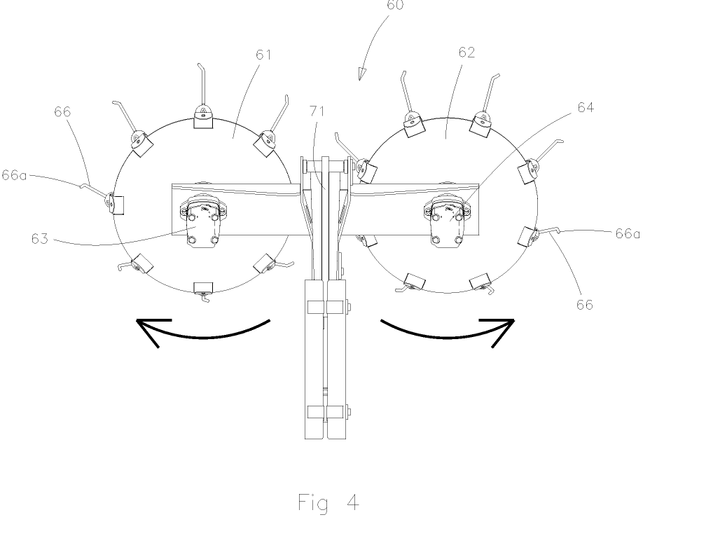

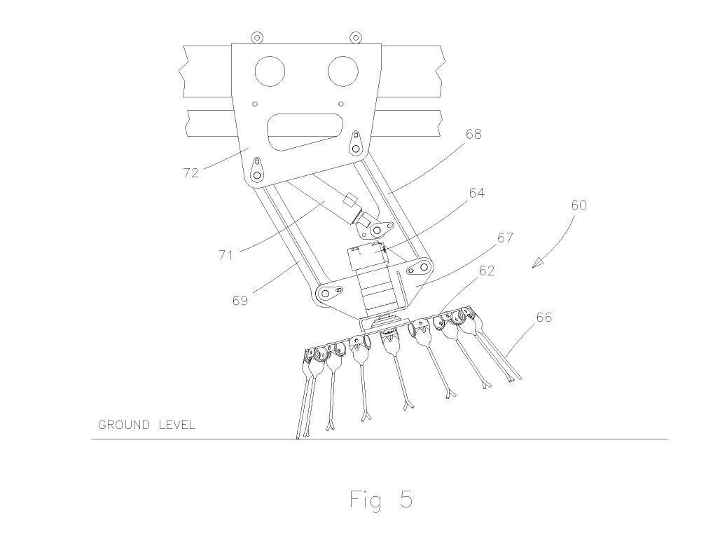

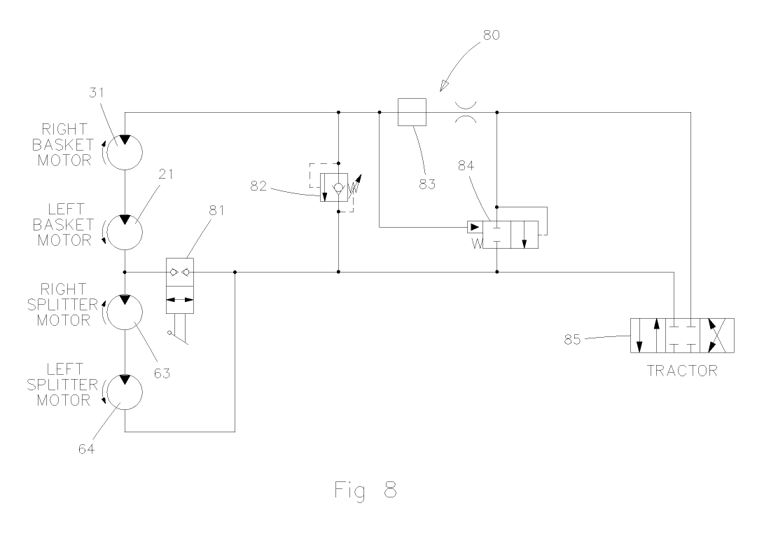

FIG. 1 shows a powered center rake attachment operatively attached to the rake 100. FIG. 2 shows the rake 100 in use without using the attachment 60, in which case the folding twin basket rake works just like the one in the aforementioned published patent application. In FIG. 2 the attachment 60 is raised and is not powered, i.e. the two powered splitter rotors 61 and 62 are raised but are not being rotated. FIG. 3, however, shows the attachment 60 in an operative position wherein it is lowered to the position shown in FIG. 5. In that position, rotor 61 is rotated in a clockwise position as viewed from above and the wheel 62 is rotated in a counterclockwise position as viewed from above in FIG. 4. Splitter rotors 61 and 62 are powered by hydraulic motors 63 and 64 (also shown in FIG. 8) respectively to cause the rotation described above and as indicated by the directional arrows in FIG. 4. Attention is directed to the fact that the outermost portion of the ends 66a of the tines 66 on powered splitter rotors 61 and 62 trail the rest of the respective tine 66. This orientation of the tines prevents each tine 66 from dragging the crop back towards the center of the rake after each secondary windrow 51 and 52 is formed as shown in FIG. 3. In certain crops the tine direction could be switched for more aggressive spreading.

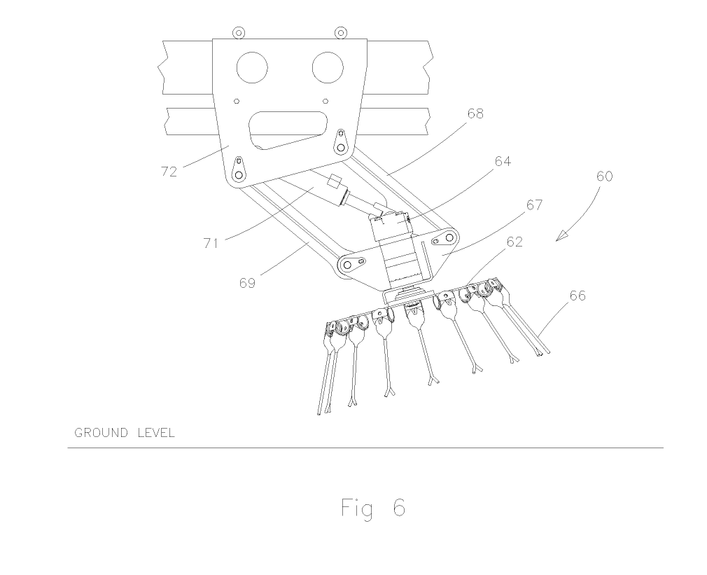

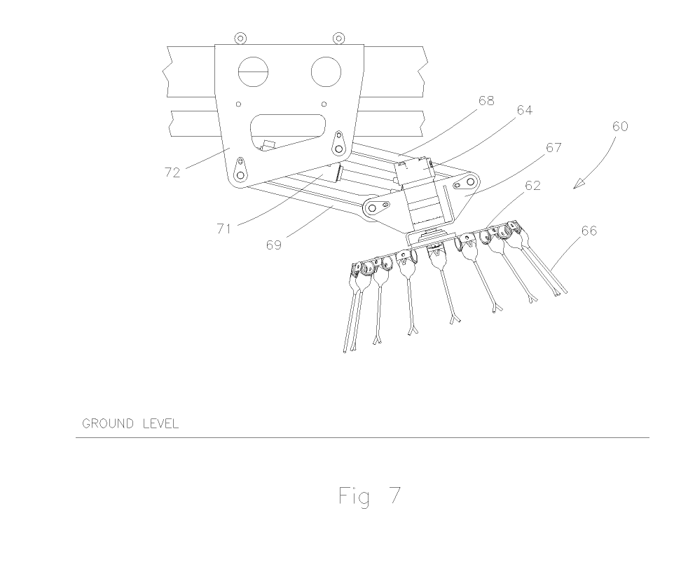

FIGS. 4-7 shows a parallelogram linkage 67, 68, 69, and 72, pivotally connected, which parallelogram linkage raises and lowers the splitter rotors 61 and 62 though with a hydraulic cylinder 71 which is pivotally attached to member 72 at the top and to member 68 at the bottom of the hydraulic cylinder 71. This hydraulic cylinder 71 is a double acting one, but could be one which merely raises the splitter rotors 61 and 62 and relies on the weight of the splitter rotors 61 and 62 to lower it, or they could alternatively be lowered to the lowest position shown in FIG. 5 using a spring, not shown, to assist gravity.

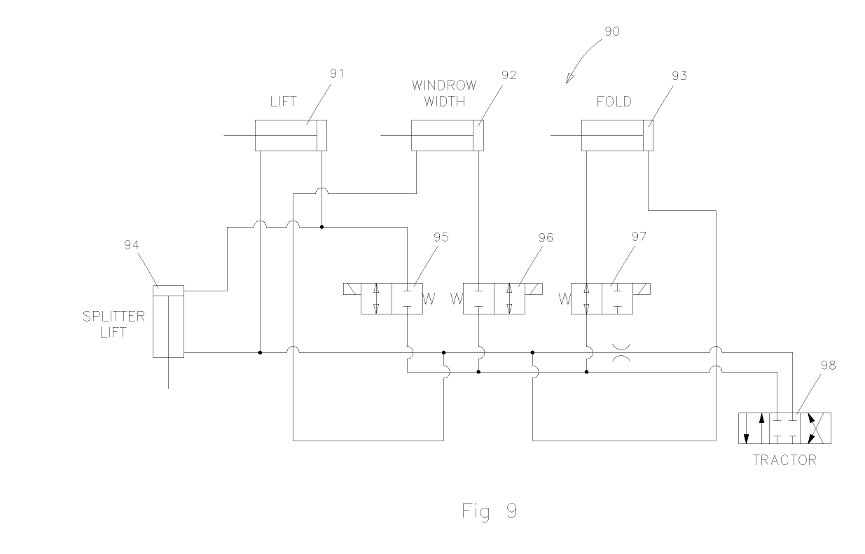

FIG. 8 shows a schematic hydraulic system 80 for rotating the basket rakes 20 and 30 using hydraulic motors 21 and 31 respectively and rotating the right and left rotor 61 and 62 respectively of the center attachment 60 used to form secondary windrows 51 and 52 as shown in FIG. 2. FIG. 9 shows schematically a hydraulic lift system for raising or lowering the various parts of the rake 100.

In operation, the rake 100 is towed into a field while in a transport position as shown in FIG. 1. Looking to FIG. 9 a separate hydraulic lever 98 would be positioned inside a tractor cab, not shown. The schematic circuits of FIGS. 8 and 9 control the basic rake of FIGS. 1-9. Valves 98 and 85 each have an operating lever on them and are in the tractor cab. After the operator pulls the rake 100 of FIG. 1 into a cut hay field or the like in the transport position shown in FIG. 1, the operator then gets ready to rake the hay shown in FIGS. 2 and 3. The operator would first actuate the valve 98 to move the rake 100 from the transport position in FIG. 1 to the operative position in FIG. 2.

When the valve 98 is activated and the electric controller is in the transport position that closes the cartridge 97 and opens valve 95 thereby sending oil to lift cylinders 91 and 94 simultaneously. That, in turn, moves the rake 100 from the transport position shown in FIG. 1 to the operating position in FIG. 3. The folding and unfolding of the rake 100 operates like that shown in U.S. patent application Ser. No. 11/161,594 filed Aug. 9, 2005, now published U.S. Patent Application No. 20070033915, now U.S. Pat. No. ______, which patent application has been incorporated herein by reference in its entirety. The raising and lowering of the rotor 60, as shown in FIGS. 2, 3 and 5-7 is the basic invention just added to the operation of the folding rake shown and described in the just mentioned previously filed patent application. The rotor 60 is plumbed in line, so when the rake 100 is lowered, the rotor 60 lowers as is shown in FIG. 9 schematically and also shown in part by hydraulic cylinder 91 of FIG. 1.

If it is not desired to use the splitter 60, then hydraulic cylinder 91 is used to lift splitter 60 up off the ground and the rake 100 can be used as shown in FIG. 2 in the way the rake 100 would be used if it did not have splitter 60 on it. After the rake 100 is folded out to the position shown in FIG. 3, the operator engages the valve 85. Before the operator turns on valve 85, shown in FIG. 8, the operator needs to decide if the splitter 60 is to be on or off. If the choice is made to have the splitter on, then valve 81 has to be shut off as shown in FIG. 8. Valve 81 operates by use of a manual lever. The operator needs to just shift valve 81 to shut it. So if it is desired to run the splitter 60, oil is sent from valve 85 to the right basket motor 31 and oil goes in series to the left basket motor 21. Since valve 81 is closed, the oil goes to the right splitter motor 63. From there it goes to left splitter motor 64. After that the oil goes back to the tank 83.

If it is desired not want to run the splitter 60, then the lever of valve 81 is manually moved to the opposite position as that shown in FIG. 8. Valve 81 is essentially just sending the oil through the path of less resistance. The oil will be going to basket motors 31, 21 and then back to tank 83 instead of turning motors 63 and 64.

Components 82, 83 and 84 are working in conjunction with each other to set the speed. This speed is the exact same as current rates. Valve 82 operates to shut it off when needed. For example, if the operator coasts to a stop or if the operator runs into a stationary object, a pressure as high as two thousand (2,000) PSI might develop in the hydraulic system. This high pressure will cause component 82 to shut the rake off.

Referring back to the basic operation of the rake 100, the operator would continue to use the rake 100 by pulling the tractor forwardly for example as shown in FIG. 3, and by doing that the splitter 60 is going to pick up the hay and move it into smaller windrows 52 and 51 that end up being in front of the twin basket rakes 20 and 30 respectively. Then those windrows 51 and 52 get folded back into the main windrow 50. This insures that all of the hay or other crop gets picked up from the ground to dry and to make it easier for the baler to pick it up.

Assume that an entire hay field is covered in hay and a standard twin rake is being used without the present invention on it, i.e. only the baskets rakes 20 and 30 would be used to rake the cut hay. Also, assume for the sake of this example that the windrow is set to a four foot windrow. The baskets 20 and 30 would never rake that 4-foot center section between the baskets 20 and 30. In the present invention, the splitter 60 is picking up that material in the four foot strip between the basket rakes 20 and 30 up and throwing it outwardly. This action will help the hay or other crop to dry and it helps the baler to pickup that crop, because now that crop material is not down close to the ground but has been lifted off the ground. With this new invention 100, including splitters 60, every strip of hay on the field has been lifted at least once before the baler comes along to pick it up and bale it.

FIG. 2 essentially shows the old way of raking before this invention and FIG. 3 shows the new way using the invention 100. But there are still times when using this invention 100 that an operator might want to use the FIG. 2 configuration. For example if the crop was already swathed with a mower conditioner there might already be open area like that shown in FIG. 3 between the basket rakes 20 and 30, i.e. there would be two swathed windrows hitting the baskets. In such a case there might not be a need for the splitter 60. So in such a case the splitter 60 could be raised and turned off if desired as shown in FIG. 2. In other words, if the operator is combining two windrows into one instead of just raking hay that has been cut (for example if a mower conditioner went through the field and cut two paths side-by-side) the rake configuration of FIG. 2 could be used to pick up both of the two cut sections and throw the two cut sections into one windrow. This could be done because there would be no crop in the middle, between the two basket rakes 20 and 30, to be moved.

Whenever the raking operation is completed for the day and the operator wants to leave the field, the operator would first actuate the valve 85 shown in FIG. 8, in the opposite direction to the one previously indicated above, to turn off the rotation of the baskets 20 and 30 and the splitter 60. Then, by moving the lever of valve 98 in the tractor cab shown in FIG. 9 in an opposite direction to the one previously indicated above, the valve 98 will cause a chain reaction in the circuit shown in FIG. 9 to fold the rake 100 back to the transport position shown in FIG. 1.

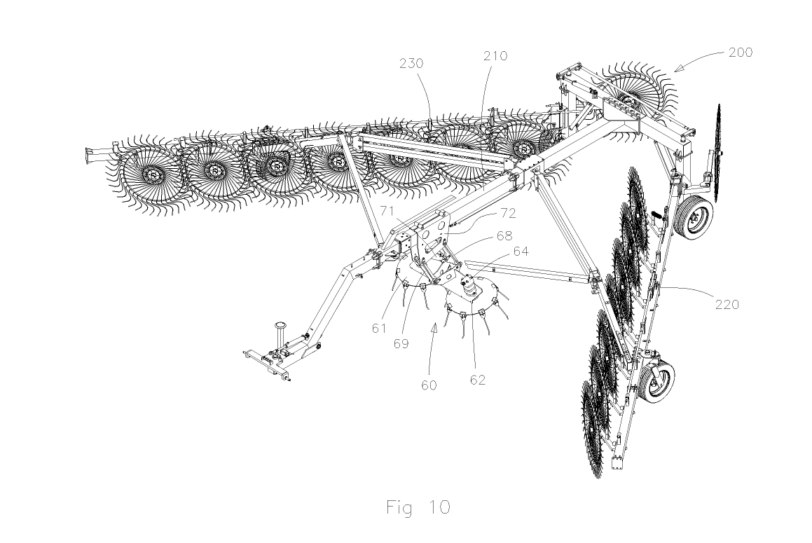

FIG. 10 shows the attachment 60 of the present invention attached to a folding twin rake wheel type rake 200. This rake 200 has a center frame 210 and wings 220 and 230 operatively pivotally attached to the center frame 210. The attachment 60 of the present invention is operatively attached to the center frame 210 in the same manner that the attachment 60 is attached to center frame 10 of the embodiment of FIGS. 1-7.

Obviously many modifications and variations of the present invention are possible in light of the above teachings. It is therefore to be understood that, within the scope of the appended claims, the invention may be practiced otherwise than as specifically described.

1. An implement for raking a crop disposed on ground in a field, the implement comprising:
(a) a frame adapted to be operatively attached to a prime mover, the frame having a front end and a rear end and being adapted to be moved in a forward direction by the prime mover;
(b) a first raking device having an inner end and an outer end, the first raking device being operatively attached to the frame for moving a crop inwardly towards the inner end thereof to form part of a first windrow;
(c) a second raking device having an inner end and an outer end, the second raking device being operatively attached to the frame for moving a crop inwardly towards the inner end thereof to form another part of the first windrow;
(d) the inner end of the first raking device being spaced from the inner end of the second raking device, thereby forming a space between the inner ends of the first and second raking devices, a front end of said first windrow being disposed at least partially in said space;
(e) a third raking device disposed forwardly of the space between the first and second raking devices for moving a crop outwardly and to at least one side of the space to form a second windrow in front of and between the inner and outer ends of at least one of the first and second raking devices; and
(f) a power device for operating the third raking device, which power device is independent from any forces due purely to contact with the ground; and
(g) a four bar parallelogram means operatively attached to the frame for selectively moving the third raking device between a crop engaging position and a transport position.

2. The implement of claim 1 wherein the third raking device forms a third windrow in front of and between the inner and outer ends of the other one of the first and second raking devices.

3. The implement of claim 1 wherein the third raking device comprises a first member operatively rotationally attached to the frame for rotation about a first axis;
a first plurality of tines operatively attached to the first member for contact with a crop disposed on the ground.

4. The implement of claim 3 wherein the third raking device comprises a second member operatively rotationally attached to the frame for rotation about a second axis;
a second plurality of tines operatively attached to the first member for contact with a crop disposed on the ground.

5. The implement of claim 4 wherein the first plurality of tines move in a first path of travel and the second plurality of tines move in a second path of travel and wherein the first and second paths of travel intersect each other whereby there is overlapping of raking of the first and second plurality of tines.

6. The implement of claim 5 wherein the first and second axes are disposed transversely to a plane approximating the top of the ground below the third raking device.

7. The implement of claim 5 wherein the first and second axes are disposed more vertically than they are disposed horizontally with respect to the top of the ground.

8. The implement of claim 7 wherein the first and second axes are disposed such that a top portion of these axes are positioned forwardly of a bottom portion of these axes whereby the first and second path of travel of the first and second plurality of tines is lower in the front than in the rear whereby, in a dynamic sense, tines in the front are closer to the ground than tines disposed at the rear of the third raking device.

9. The implement of claim 7 wherein the first and second axes are disposed at an angle of between 5 and 25 degrees forward of perpendicular with respect to a plane approximating the top of the ground below the third raking device whereby a leading edge of the first and second plurality of teeth contact the crop first, the leading edges of the first and second plurality of teeth rotating outwardly from a place where the first and second paths of travel of the first and second plurality of teeth intersect each other.

10. The implement of claim 9 wherein the first member rotates in a clockwise direction as viewed from above and the second member rotates in a counter clockwise direction as viewed from above.

11. The implement of claim 10 wherein the tines of the first plurality of tines have a top and a bottom and are bent in one direction at the bottom thereof and the tines of the second plurality of tines have a top and a bottom and are bent in a direction opposite to said one direction at the bottom thereof.

12. The implement of claim 10 wherein the first member is generally disposed in a first plane and the first plurality of tines are disposed at an angle downwardly from the first plane, and the second member is generally disposed in a second plane and the second plurality of tines are disposed at an angle downwardly from the second plane.

13. The implement of claim 1 wherein the first raking device is a basket rake.

14. The implement of claim 1 wherein the second raking device is a basket rake.

15. The implement of claim 1 wherein the first raking device is a wheel rake.

16. The implement of claim 1 wherein the second raking device is a wheel rake.

17. The implement of claim 4 the power device includes at least one hydraulic motor operatively attached to the first and second members for causing the first and second members to selectively rotate.

18. The implement of claim 4 the power device includes a first hydraulic motor operatively attached to the first member for causing the first member to rotate in a clockwise direction and a second motor operatively attached to the second member for causing the second member to selectively rotate in a counterclockwise direction.

19. The implement of claim 18 further comprising control means for controlling the first and second hydraulic motors for selectively causing the first and second hydraulic motors to rotate and for selectively turning the first and second hydraulic motors on or off.

20. (canceled)

21. (canceled)

22. The implement of claim 18 further comprising control means for automatically causing the first and second hydraulic motors to rotate when the third raking device is lowered to the crop engaging position and for selectively turning off the first and second hydraulic motors when the third raking means is raised to the transport position.

23. The implement of claim 22 including means for folding the first and second rake devices between an extended operative position and a folded transport position.

24. The implement of claim 23 including further means for causing the third raking device to be automatically lowered to the crop engaging position when the first and second rake devices are moved to the extended operative position and causing the third raking device to be automatically raised when the first and second rake devices are moved to the folded transport position.

25. The implement of claim 4 including a first motor operatively attached to the first member for selectively causing the first member to rotate and a second motor operatively attached to the second member for causing the second member to selectively rotate.

26. The implement of claim 25 wherein the first member is rotated in one direction and the second member is rotated in an opposite direction.

27. A method for raking a crop disposed on ground in a field, the method comprising:
(a) positioning a first raking device having an inner end and an outer end in the field for moving the crop inwardly towards the inner end thereof to form part of a first windrow;
(b) positioning a second raking device having an inner end and an outer end in the field for moving the crop inwardly towards the inner end thereof to form another part of the first windrow;
(c) positioning the inner end of the first raking device so it is spaced from the inner end of the second raking device, thereby forming a space between the inner ends of the first and second raking devices and thereby causing a front end of said first windrow to be disposed at least partially in said space; and
(d) positioning a third raking device at a position forwardly of the space between the first and second raking devices for moving a crop outwardly and to at least one side of the space to form a second windrow in front of and between the inner and outer ends of at least one of the first and second raking devices;
(e) simultaneously moving the first, second and third raking devices forwardly to cause all of the crop in the second windrow to be disposed within the first windrow;
using the third raking device to form a third windrow in front of and between the inner and outer ends of the other one of the first and second raking devices so that this third windrow forms a part of the first windrow as the first, second and third raking devices are moved forwardly through the field: and wherein at least some of the tines in the plurality of first and second plurality of tines has an upper part and a lowermost part and wherein the lowermost part is bent rearwardly with respect to the uppermost part and the lowermost part is disposed behind the uppermost part during operation of the third raking device.

28. (canceled)

29. (canceled)

30. An implement for raking a crop disposed on ground in a field, the implement comprising:
(a) a frame adapted to be operatively attached to a prime mover, the frame having a front end and a rear end and being adapted to be moved in a forward direction by the prime mover;
(b) a first raking device having an inner end and an outer end, the first raking device being operatively attached to the frame for moving a crop inwardly towards the inner end thereof to form part of a first windrow;
(c) a second raking device having an inner end and an outer end, the second raking device being operatively attached to the frame for moving a crop inwardly towards the inner end thereof to form another part of the first windrow;
(d) the inner end of the first raking device being spaced from the inner end of the second raking device, thereby forming a space between the inner ends of the first and second raking devices, a front end of said first windrow being disposed at least partially in said space;
(e) a third raking device disposed forwardly of the space between the first and second raking devices for moving a crop outwardly and to at least one side of the space to form a second windrow in front of and between the inner and outer ends of at least one of the first and second raking devices;
(f) wherein the third raking device comprises a first member operatively rotationally attached to the frame for rotation about a first axis, the first axis being disposed more vertically disposed horizontally with respect to the top of the ground; and
(g) a first plurality of tines operatively attached to the first member for contact with a crop disposed on the ground; and
(h) a four bar parallelogram means operatively attached to the frame for selectively moving the third raking device between a crop engaging position and a transport position.

31. The implement of claim 30 wherein the third raking device comprises a second member operatively rotationally attached to the frame for rotation about a second axis;
a second plurality of tines operatively attached to the first member for contact with a crop disposed on the ground.

32. The implement of claim 31 wherein the first plurality of tines move in a first path of travel and the second plurality of tines move in a second path of travel and wherein the first and second paths of travel intersect each other whereby there is overlapping of raking of the first and second plurality of tines.

33. The implement of claim 32 wherein the first and second axes are disposed transversely to a plane approximating the top of the ground below the third raking device.

34. The implement of claim 32 wherein the second axis is disposed more vertically than disposed horizontally with respect to the top of the ground.

35. The implement of claim 34 wherein the first and second axes are disposed such that a top portion of these axes are positioned forwardly of a bottom portion of these axes whereby the first and second path of travel of the first and second plurality of tines is lower in the front than in the rear whereby, in a dynamic sense, tines in the front are closer to the ground than tines disposed at the rear of the third raking device.

36. The implement of claim 34 wherein the first and second axes are disposed at an angle of between 5 and 25 degrees forward of perpendicular with respect to a plane approximating the top of the ground below the third raking device whereby a leading edge of the first and second plurality of teeth contact the crop first, the leading edges of the first and second plurality of teeth rotating outwardly from a place where the first and second paths of travel of the first and second plurality of teeth intersect each other.

37. The implement of claim 36 wherein the first member rotates in a clockwise direction as viewed from above and the second member rotates in a counter clockwise direction as viewed from above.

38. The implement of claim 36 wherein the tines of the first plurality of tines have a top and a bottom and are bent in one direction at the bottom thereof and the tines of the second plurality of tines have a top and a bottom and are bent in a direction opposite to said one direction at the bottom thereof

39. The implement of claim 36 wherein the first member is generally disposed in a first plane and the first plurality of tines are disposed at an angle downwardly from the first plane, and the second member is generally disposed in a second plane and the second plurality of tines are disposed at an angle downwardly from the second plane.

40. The implement of claim 31 the power device includes at least one hydraulic motor operatively attached to the first and second members for causing the first and second members to selectively rotate.

41. The implement of claim 31 the power device includes a first hydraulic motor operatively attached to the first member for causing the first member to rotate in a clockwise direction and a second motor operatively attached to the second member for causing the second member to selectively rotate in a counterclockwise direction.

42. The implement of claim 41 further comprising control means for controlling the first and second hydraulic motors for selectively causing the first and second hydraulic motors to rotate and for selectively turning the first and second hydraulic motors on or off.

43. (canceled)

44. (canceled)

45. The implement of claim 41 further comprising control means for automatically causing the first and second hydraulic motors to rotate when the third raking device is lowered to the crop engaging position and for selectively turning off the first and second hydraulic motors when the third raking means is raised to the transport position.

46. The implement of claim 45 including means for folding the first and second rake devices between an extended operative position and a folded transport position.

47. The implement of claim 26 including further means for causing the third raking device to be automatically lowered to the crop engaging position when the first and second rake devices are moved to the extended operative position and causing the third raking device to be automatically raised when the first and second rake devices are moved to the folded transport position.

48. The implement of claim 31 including a first motor operatively attached to the first member for selectively causing the first member to rotate and a second motor operatively attached to the second member for causing the second member to selectively rotate.

49. The implement of claim 48 wherein the first member is rotated in one direction and the second member is rotated in an opposite direction.

50. An implement for raking a crop disposed on ground in a field, the implement comprising:
(a) a frame adapted to be operatively attached to a prime mover, the frame having a front end and a rear end and being adapted to be moved in a forward direction by the prime mover;
(b) a first raking device having an inner end and an outer end, the first raking device being operatively attached to the frame for moving a crop inwardly towards the inner end thereof to form part of a first windrow;
(c) a second raking device having an inner end and an outer end, the second raking device being operatively attached to the frame for moving a crop inwardly towards the inner end thereof to form another part of the first windrow;
(d) the inner end of the first raking device being spaced from the inner end of the second raking device, thereby forming a space between the inner ends of the first and second raking devices, a front end of said first windrow being disposed at least partially in said space;
(e) a third raking device disposed forwardly of the space between the first and second raking devices for moving a crop outwardly and to at least one side of the space to form a second windrow in front of and between the inner and outer ends of at least one of the first and second raking devices; a power device for operating the third raking device, which power device is independent from any forces due purely to contact with the ground;
(g) wherein the third raking device forms a third windrow in front of and between the inner and outer ends of the other one of the first and second raking devices.
(h) wherein the third raking device comprises a first member operatively rotationally attached to the frame for rotation about a first axis;
(i) a first plurality of tines operatively attached to the first member for contact with a crop disposed on the ground;
(j) wherein the third raking device comprises a second member operatively rotationally attached to the frame for rotation about a second axis;
(k) a second plurality of tines operatively attached to the first member for contact with a crop disposed on the ground.
(l) wherein the first plurality of tines move in a first path of travel and the second plurality of tines move in a second path of travel and wherein the first and second paths of travel intersect each other whereby there is overlapping of raking of the first and second plurality of tines;
(m) wherein the first and second axes are disposed transversely to a plane approximating the top of the ground below the third raking device;
(n) wherein the first and second axes are disposed at an angle of between 5 and 25 degrees forward of perpendicular with respect to a plane approximating the top of the ground below the third raking device whereby a leading edge of the first and second plurality of teeth contact the crop first, the leading edges of the first and second plurality of teeth rotating outwardly from a place where the first and second paths of travel of the first and second plurality of teeth intersect each other;
(o) wherein the first member rotates in a clockwise direction as viewed from above and the second member rotates in a counter clockwise direction as viewed from above; and
(p) wherein the tines of the first plurality of tines have a top and a bottom and are bent in one direction at the bottom thereof and the tines of the second plurality of tines have a top and a bottom and are bent in a direction opposite to said one direction at the bottom thereof

51. The implement of claim 50 wherein the first member is generally disposed in a first plane and the first plurality of tines are disposed at an angle downwardly from the first plane, and the second member is generally disposed in a second plane and the second plurality of tines are disposed at an angle downwardly from the second plane.

52. The implement of claim 50 wherein the first and second axes are disposed such that a top portion of these axes are positioned forwardly of a bottom portion of these axes whereby the first and second path of travel of the first and second plurality of tines is lower in the front than in the rear whereby, in a dynamic sense, tines in the front are closer to the ground than tines disposed at the rear of the third raking device.
